(19) United States
(12) Patent Application Publication
(10) Pub. No.: US 2016/0146014 A1
(43) Pub. Date: May 26, 2016

(54) MODIFIED BUCKET PLATFORMS OF TURBINE BUCKETS AND METHODS FOR MODIFYING BUCKET PLATFORMS OF TURBINE BUCKETS

(71) Applicant: General Electric Company, Schenectady, NY (US)

(72) Inventors: James Ryan Connor, Greenville, SC (US); Robert Trent Hullender, Simpsonville, SC (US); Keith Alan Lord, Taylors, SC (US)

(73) Assignee: General Electric Company

(21) Appl. No.: 14/548,656

(22) Filed: Nov. 20, 2014

(51) Int. Cl. F01D 5/14; B23H 9/10; F01D 5/00

(52) U.S. Cl. CPC F01D 5/147; F01D 5/005; B23H 9/10; F05D 2230/12; F05D 2220/3212; F05D 2230/80; F05D 2240/30

(57) ABSTRACT

Methods for modifying bucket platforms of turbine buckets include removing a portion of the bucket platform to form a void, wherein the void comprises a predetermined geometry, and adding a filler material in a plurality of layers to fill the void.

### BACKGROUND OF THE INVENTION

The subject matter disclosed herein relates to modifying turbine buckets and, more specifically, to modifying bucket platforms of turbine buckets.

Turbine buckets for industrial applications can experience extended service cycles in hostile conditions that may include operating temperatures exceeding 1400° C. High temperature performance alloys (such as nickel and cobalt super alloys) may be utilized to extend service life of these turbine components. However, even these high performance alloys may be subject to erosion, oxidation or other distress. Turbine buckets may therefore undergo modification to provide for continued operation (e.g., through repair, adjustment, upgrades, etc.). For example, bucket platforms may undergo modification to potentially remedy areas of oxidation or erosion. However, the modification of such high temperature performance alloys may be difficult, particularly when only addressing localized areas. Moreover, each bucket may present unique considerations potentially leading to individualized modifications.

Accordingly, alternative modified turbine buckets and methods for modifying turbine buckets would be welcome in the art.

### BRIEF DESCRIPTION OF THE INVENTION

In one embodiment, a method for modifying a bucket platform of a turbine bucket is disclosed. The method includes removing a portion of the bucket platform to form a void, wherein the void comprises a predetermined geometry, and adding a filler material in a plurality of layers to fill the void.

In another embodiment, a method for modifying a plurality of bucket platforms of a plurality of turbine buckets is disclosed. The method includes removing a portion from each of the plurality of bucket platforms to form a void on each of the plurality of bucket platforms, wherein each void comprises a single predetermined geometry, and adding a filler material in a plurality of layers to fill each of the voids.

In yet another embodiment, a modified turbine bucket is disclosed. The modified turbine bucket includes an airfoil extending from a bucket platform and a root portion extending from an opposite side of the bucket platform. The modified turbine bucket further includes the bucket platform comprising a filler material disposed in a plurality of layers that fills a previously formed void comprising a predetermined geometry.

These and additional features provided by the embodiments discussed herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference numerals and in which:

FIG. 1 is a method for modifying a bucket platform of a turbine bucket according to one or more embodiments shown or described herein;

FIG. 2 is a perspective view of a turbine bucket with an original bucket platform according to one or more embodiments shown or described herein;

FIG. 3 is a perspective view of a turbine bucket with a portion of the bucket platform being removed to form a void according to one or more embodiments shown or described herein;

FIG. 4 is an enlarged perspective view of a portion of the void illustrated in FIG. 3 according to one or more embodiments shown or described herein; and,

FIG. 5 is a perspective view of a turbine bucket with a modified bucket platform according to one or more embodiments shown or described herein.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

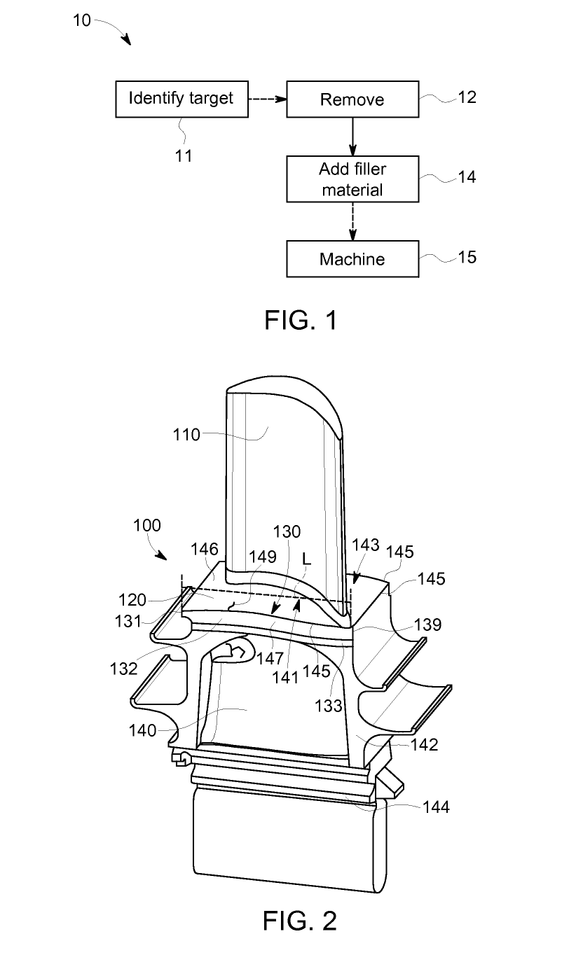

Referring to FIGS. 1-5, a method 10 is illustrated for modifying a turbine bucket 100, and, more specifically, modifying a bucket platform 120 of the turbine bucket 100. As best illustrated in FIG. 2, a turbine bucket 100 generally comprises an airfoil 110 extending from a bucket platform 120 and a root portion 140, including a shank 142 and a dovetail 144, extending from an opposite side of the bucket platform 120. It should be appreciated that the turbine bucket 100, when placed in a turbine wheel (not illustrated) is one of an annular array of turbine buckets secured about the periphery of the turbine wheel. While axial entry buckets are disclosed herein, it should also be appreciated that the embodiments hereof may also be applied to tangential entry buckets. Furthermore, while FIGS. 2-5 illustrate turbine buckets 100 at various stages of the method 10, it should be appreciated that these illustrations are exemplary only and other turbine buckets 100 embodying additional or alternative features may also be realized.

Still referring to FIG. 2, the bucket platform 120 of the turbine bucket 100 can comprise a slash face 130 (e.g., an edge 145) on each side of the airfoil 110. The slash face 130 can extend the entire length L of the bucket platform 120 from the leading side 131 to the trailing side 139. When installed on a turbine wheel, the slash face 130 of the turbine bucket 100 may circumferentially oppose an adjacent slash face of an adjacent turbine bucket (not illustrated) to form a gap there between. In some embodiments, each slash face 130 may additionally comprise a groove 133 for receiving a damper pin (not illustrated) to operate as a vibration damper.

The turbine bucket 100 can comprise any suitable material or materials such as high temperature performance alloys (e.g., nickel and cobalt based super alloys). Furthermore, the turbine bucket 100 can comprise any stage turbine bucket for any frame turbine. In some specific embodiments, the turbine bucket 100 may comprise a first stage turbine bucket that experiences higher operating temperatures than subsequent stage turbine buckets.

Referring now in particularly to FIGS. 1-5, the method 10 is illustrated for modifying the turbine bucket 100, and, more specifically, modifying the bucket platform 120 of the turbine bucket 100. The method 10 first comprises removing at least a portion of the bucket platform 120 to form a void 150. The void 150 comprises a predetermined geometry such that the void 150 may be subsequently filled in with a plurality of layers 137 of a filler material 135 such as through an automated additive manufacturing process. The utilization of the void 150 with a predetermined geometry can facilitate subsequent layer-by-layer filling for more repeatable and consistent modification operations with a higher level of quality control.

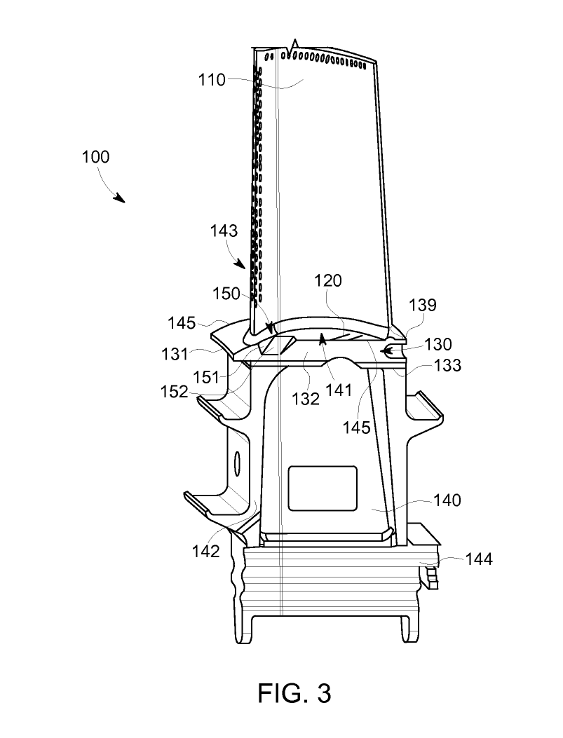

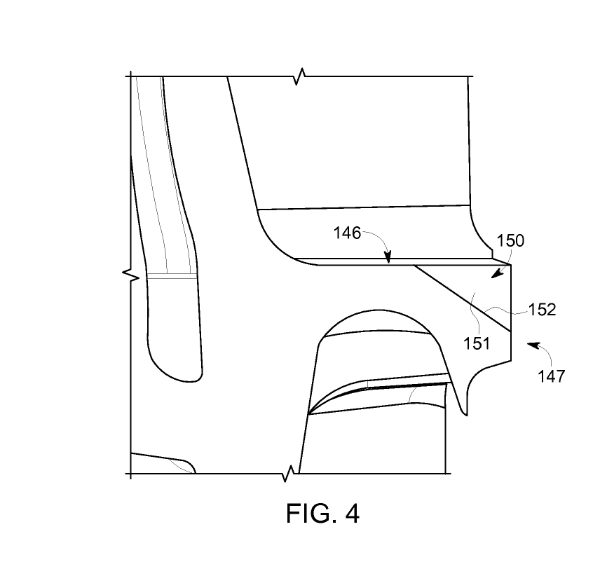

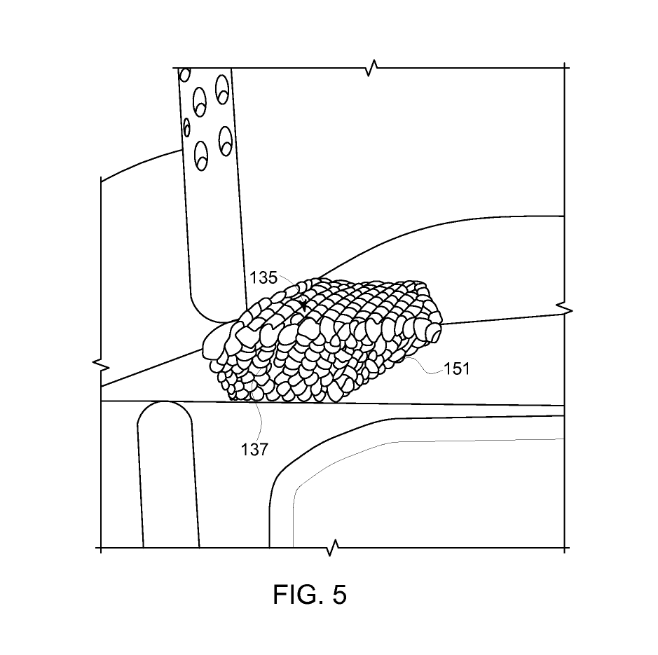

As best illustrated in FIGS. 3-4, the predetermined geometry of the void 150 may comprise any predetermined geometry that facilitates subsequent filling via a plurality of layers 137 (e.g., through an additive manufacturing filling process). For example, in some embodiments, the void 150 may comprise one or more side walls 151 and/or one or more floors 152. In some embodiments, at least one of the side walls 151 and/or floors 152 may comprise a non-vertical orientation. Non-vertical orientation can refer to a side wall 151 that does not traverse in a straight up-and-down direction. For example, a non-vertical orientation can include tapering away from the floor 152 as illustrated in FIGS. 3-5. By providing one or more non-vertical surfaces, the void 150 may facilitate the positioning of one or more machines for disposing a subsequent filler material 135 in a plurality of layers 137 as illustrated in FIG. 5. For example, the non-vertical orientation can provide additional space to accommodate a deposition tip and corresponding robotic positioning device of an additive manufacturing machine as it deposits material towards the outer portion of each individual layer.

In some embodiments, the one or more sidewalls 151 may taper to provide the non-vertical orientation. For example, as illustrated in FIGS. 3-5, the void 150 may comprise two sidewalls 151 that extend from a floor 152 of the void 150 to the top surface 146 of the bucket platform 120. The sidewalls 151 may taper away from the floor 152 such that the top opening of the void 150 is larger than the bottom surface. Moreover, the one or more sidewalls 151 may comprise linear or non-linear configurations. For example, the predetermined geometry of the void 150 may comprise a scallop configuration with curved sidewalls 151.

In even some embodiments, the predetermined geometry may comprise a single predetermined geometry; i.e., a common shared geometry that is utilized on multiple turbine bucket modification operations either involving the same single turbine bucket 100 or multiple different turbine buckets 100. For example, two different turbine buckets 100 may undergo a modification of their respective bucket platforms 120. Portions of material may be removed therefrom so as to form voids 150 on each respective bucket platform 120 wherein each void 150 has the same single predetermined geometry. The voids 150 may be formed in the same relative location (such as when cracks are located at the same relative location) or the voids 150 may be formed in different relative locations (such as when cracks are located at different relative locations). The single geometry used for a plurality of voids can facilitate a common material filling operation used across all modifications so that the specifics of the plurality of layers (e.g., size, number, thickness, etc.) is the same for every void 150.

Removal of the portion of the bucket platform 120 in step 12 of method 10 may occur through any suitable tools, methods or combinations thereof such that the void 150 of the predetermined geometry is formed in the bucket platform 120. For example, in some embodiments removal in step 12 may occur via milling, grinding, machining, drilling, cutting or the like and may be automated, manual or combinations thereof. For example, in some embodiments, removing the portion of the bucket platform 120 in step 12 may comprise utilizing electrical discharge machining (EDM). Removal in step 12 may also occur via one single pass or through multiple iterations. In some embodiments, removal in step 12 may comprise multiple processes. For example, removal in step 12 may comprise an initial bulk removal process such as EDM followed by a finishing process such as grit blasting or the like.

The void 150 may be formed at a variety of locations on the bucket platform 120 of the turbine bucket 100. In some embodiments, the void 150 may be formed on one or more of the edges 145 of the bucket platform 120. For example, the void 150 may be formed on the edge 145 of the leading side 131, the pressure side 141, the trailing side 139, or the suction side 143. In some particular embodiments, the void 150 may be formed on the edge 145 of the pressure side 141 more proximate to the leading side 131 than the trailing side 139. Said embodiments may allow for modification of the bucket platform 120 around areas of particularly high stress. Furthermore, depending on the location of the void 150 and its predetermined geometry, the void 150 may extend between multiple surfaces of the bucket platform 120. For example, the void 150 may extend from a top surface 146 of the bucket platform 120 to a side surface 147 (such as the side surface 147 along the pressure side 141 and/or the leading side 131) of the bucket platform 120.

As illustrated in FIG. 2, in some particular embodiments, the portion of the bucket platform 120 removed to form the void 150 may comprise a target location 149 that is to be removed therefrom. The target location 149 may comprise any particular area that is to be modified, such as a potential crack, defect, oxidation zone or other area that could potentially use repair. For example, the method 10 may first comprise an initial step 11 of identifying the target area such that removal of a portion of the bucket platform in step 12 comprises removing a portion around the target area.

Referring now to FIGS. 1 and 4-5, the method 10 further comprises adding a filler material 135 (illustrated in FIG. 5) in step 14 in a plurality of layers 137 to fill the void 150 in the bucket platform 120. By adding filler material 135 in a plurality of layers 137, the void 150 can be filled using any additive manufacturing process to provide consistent modification of the predetermined geometry. Additive manufacturing can refer to any process which results in a three-dimensional deposition of material and includes a step of sequentially forming the shape of the object one layer at a time. Additive manufacturing processes include, for example, three dimensional printing, laser-net-shape manufacturing, direct metal laser sintering (DMLS), direct metal laser melting (DMLM), plasma transferred arc, freeform fabrication, and the like. One exemplary type of additive manufacturing process uses a laser beam to sinter or melt a powder material. Additive manufacturing processes can employ powder materials or wire as a raw material. Moreover additive manufacturing processes can generally relate to a rapid way to manufacture an object (article, component, part, product, etc.) where a plurality of thin unit layers are sequentially formed to produce the object. For example, layers of a powder material may be provided (e.g., laid down) and irradiated with an energy beam (e.g., laser beam) so that the particles of the powder material within each layer are sequentially sintered (fused) or melted to solidify the layer.

In some embodiments the filler material 135 may be added in a plurality of layers 137 via laser cladding. In some embodiments, other material addition methods may additionally or alternatively be used to add the plurality of layers such as welding, brazing or the like. In some embodiments, each of the plurality of layers 137 may comprise a plurality of beads (as illustrated in FIG. 5).

Moreover, in some embodiments, adding filler material 135 in step 14 may be via a common filling process (i.e., using the same filling process to deposit the same amount of layers 137 with the same dimensions for each void 150 being filled). In some embodiments, the common additive manufacturing process may be automated. Such embodiments can help facilitate repeatability in the modification process, such as when multiple turbine buckets 100 have portions of their respective bucket platforms 120 removed to provide each one with a void 150 with the same predetermined geometries.

In some embodiments, the filler material 135 may be added to the void 150 such that it exceeds the dimensions of the original bucket platform 150. In such embodiments, the added filler material 150 may subsequently be machined down to its final dimensions as will become appreciated herein.

The filler material 135 added in step 14 may comprise any suitable material for the utilization in the bucket platform 120 the turbine bucket 100 and that is susceptible to addition by a plurality of layers 137. For example, in some embodiments, the filler material 125 added in step 14 may comprise one or more of the commercially available Haynes-230, Nimonic 263, Inconel 625, GTD-111®, Rene' 142 or the like. In some embodiments, the filler material 135 may comprise the same type of material that was removed from bucket platform 120 in step 12. However, in some embodiments, the filler material 135 may comprise a different material than the original material of the bucket platform 120. For example, in some embodiments, the new material 135 may be more resistant to oxidation than the original material. In some embodiments, the filler material 135 may comprise any other suitable alloy selected based at least in part on low cycle fatigue capability, oxidation capability and/or creep capability.

Referring to FIG. 1, the method 10 may optionally further include machining the filler material 135 in step 15. Machining in step 15 may include any applicable process that shapes the added filler material 135 to its final dimensions, finishes the surface of the bucket platform 120 to suitable characteristics, and/or otherwise treats the filler material 135 prior to utilization of the turbine bucket 100.

For example, in some embodiments, after filler material 135 is added in step 14, some of the filler material 135 may be machined via milling, grinding or the like. Machining in step 15 may be automated, manual or combinations thereof. Machining in step 15 may also occur via one single pass or through multiple iterations. Machining may continue in step 15 to bring the dimensions of the filler material 135 within a specified tolerance for the modified turbine bucket 100.

As best illustrated in FIG. 5, the methods described herein may be utilized to produce a modified turbine bucket 100. The modified turbine bucket 100 comprises the airfoil 110 extending from the bucket platform 120 and the root portion 140 extending from an opposite side of the bucket platform 120. The bucket platform 120 itself comprises the filler material 135 disposed in a plurality of layers 137 that fills the previously formed void 150 comprising the predetermined geometry.

It should now be appreciated that bucket platforms of turbine buckets may be modified by removing material (e.g., removing a defect) to form a void of a predetermined geometry and subsequently filling the void with filler material in a plurality of layers (e.g., through an automated manufacturing process). By creating the void of predetermined geometry, filling operations may be consistent and repeatable for either individual turbine buckets or amongst a plurality of turbine buckets.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method for modifying a bucket platform of a turbine bucket, the method comprising:
removing a portion of the bucket platform to form a void, wherein the void comprises a predetermined geometry; and,
adding a filler material in a plurality of layers to fill the void.

2. The method of claim 1, wherein the predetermined geometry comprises one or more sidewalls comprising a non-vertical orientation.

3. The method of claim 2, wherein the one or more sidewalls comprising the non-vertical orientation taper away from a floor of the void.

4. The method of claim 2, wherein the one or more sidewalls comprising the non-vertical orientation comprise non-linear sidewalls.

5. The method of claim 1 further comprising identifying a target location of the bucket platform prior to removing the portion of the bucket platform, wherein the portion of the bucket platform removed from the turbine bucket comprises the target location.

6. The method of claim 1, wherein the void is formed on one or more edges of the bucket platform.

7. The method of claim 6, wherein the void extends from a top surface to a side surface of the bucket platform.

8. The method of claim 1, wherein the void is formed on a pressure side of the bucket platform.

9. The method of claim 8, wherein the void is more proximate a leading side of the bucket platform than a trailing side of the bucket platform.

10. The method of claim 8, wherein the void is formed on an edge of the pressure side of the bucket platform.

11. The method of claim 1, wherein removing the portion of the bucket platform comprises utilizing electrical discharge machining.

12. The method of claim 1, wherein at least one of the plurality of layers comprises a plurality of beads of the filler material.

13. The method of claim 1, wherein the filler material comprises a same material as the bucket platform.

14. The method of claim 1, further comprising finishing a surface of the filler material.

15. A method for modifying a plurality of bucket platforms of a plurality of turbine buckets, the method comprising:
removing a portion from each of the plurality of bucket platforms to form a void on each of the plurality of bucket platforms, wherein each void comprises a single predetermined geometry; and,
adding a filler material in a plurality of layers to fill each of the voids.

16. The method of claim 15, wherein the single predetermined geometry comprises one or more sidewalls comprising a non-vertical orientation.

17. The method of claim 15, wherein adding the filler material in the plurality of layers to fill each of the voids is performed by a common filling process.

18. A modified turbine bucket comprising:
an airfoil extending from a bucket platform;
a root portion extending from an opposite side of the bucket platform; and,
wherein, the bucket platform comprises a filler material disposed in a plurality of layers that fills a previously formed void comprising a predetermined geometry.

19. The modified turbine bucket of claim 18, wherein the predetermined geometry comprises one or more sidewalls comprising a non-vertical orientation.

20. The modified turbine bucket of claim 18, wherein the modified turbine bucket comprises a first stage turbine bucket.
